(19) United States
(12) Patent Application Publication
(10) Pub. No.: US 2017/0222330 A1
(43) Pub. Date: Aug. 3, 2017

(54) ANTENNA DEVICE

(71) Applicant: ROYALTEK COMPANY LTD., TAO YUAN (TW)

(72) Inventor: MING-HUNG TSAI, TAO YUAN (TW)

(21) Appl. No.: 15/008,816

(22) Filed: Jan. 28, 2016

(51) Int. Cl. H01Q 21/00; H01Q 23/00; H01Q 1/38

(52) U.S. Cl. CPC H01Q 21/0075; H01Q 1/38; H01Q 21/00; H01Q 23/00

(57) ABSTRACT

An antenna device includes a substrate having a first plane and a second plane, a plurality of cascaded antenna sets are arranged on the first plane, and each cascaded antenna set has a plurality of antenna units and a plurality of microstrip lines. Every two antenna units is electrically connected with one microstrip line, whereby the antenna units are cascaded through the microstrip lines. A signal processor is electrically connected with the middle microstrip line of each cascaded antenna set, and at least one input signal is fed into the cascaded antenna sets, and then transmitted to the outside antenna units from the middle antenna unit, thereby improving a gain of them. The present invention changes a fan-beam radiation field pattern of a cascaded antenna set into a multi-point pencil-beam radiation field pattern or a radiation field pattern with different angles, thereby increasing the overall gain.

### BACKGROUND OF THE INVENTION

Field of the Invention

The present invention relates to an antenna device, particularly to an antenna device consisting of cascaded antenna units connected together.

Description of the Related Art

In the past monolithic microstrip integrated circuits (MMICs) have been developed and various microwave dielectric materials have been proposed, whereby academia, industry and government units popularly value an antenna technology, so as to develop various products applied to a personal communication system (PCS), a global positioning system (GPS), a direct broadcasting satellite (DBS) or wireless local area networks (WLANs). As a result, the antenna technology becomes an increasingly important role and possesses high development in application and requirement.

In general, antennas are expected to achieve minimization and have high gain and multi-frequency bands. As a result, the design of antennas is valued and possesses practicability. The size of the traditional resonant antenna has to correspond to wavelengths. Since artificial material of antennas has high inductive reactance, small antennas are combined with the artificial material to achieve resonance with lower frequency. Point sources become parallel waves through the artificial material, so as to increase the antenna gain. Alternatively, the artificial material is used to form substrates or parasitical loads, thereby utilizing the properties of different frequency bands to fabricate multi-frequency antennas. With the trend of slim and compact communication products, the areas of antenna substrates are limited. Thus, how to minimize antennas and enhance their gain is a bottleneck that the existing technology intends to break. In the traditional technology, the volumes of antenna devices can be reduced without enhancing the antenna gain. The goal of high gain is achieved by using an antenna combination with a large area. Accordingly, how to minimize antennas and enhance their gain is an important bottleneck that an antenna technology will break in the future.

To overcome the abovementioned problems, the present invention provides an antenna device, which feeds signals into a middle antenna unit to change a radiation field pattern and enhance an antenna gain.

### SUMMARY OF THE INVENTION

A primary objective of the present invention is to provide an antenna device, which arranges antenna units cascaded into an array, and which feeds signals into the middle antenna unit whereby the signals are transmitted to outside from the middle antenna unit to change a radiation field pattern, and which changes a fan-beam radiation field pattern into a multi-point pencil-beam radiation field pattern or a radiation field pattern with different angles, thereby increasing the overall gain.

Another objective of the present invention is to provide an antenna device, which uses a printed circuit board to fabricate an antenna into a planar antenna to thin the antenna, and which arranges antenna units into an array to minimize the area of the antenna units to favor the reduced volume of communication products installed on the antenna device, thereby satisfying the requirement of consumers.

To achieve the abovementioned objectives, the present invention provides an antenna device. The antenna device includes a substrate, a plurality of cascaded antenna sets and a signal processor. The substrate has a first plane and a second plane. The cascaded antenna sets are arranged on the first plane of the substrate, and each cascaded antenna set has a plurality of antenna units and a plurality of microstrip lines. Every two antenna units is electrically connected with one microstrip line, whereby the antenna units are cascaded through the microstrip lines. The signal processor is electrically connected with the middle microstrip line of each cascaded antenna set, and at least one input signal is fed into the cascaded antenna sets, and then transmitted to the outside antenna units from the middle antenna unit, thereby improving a gain of the cascaded antenna sets.

Below, the embodiments are described in detail in cooperation with the drawings to make easily understood the technical contents, characteristics and accomplishments of the present invention.

### BRIEF DESCRIPTION OF THE DRAWINGS

FIG. 1 is a diagram schematically showing connections of elements of an antenna device according to the first embodiment of the present invention;

FIG. 2 is a block diagram schematically showing an antenna device according to the first embodiment of the present invention;

FIG. 3a is a diagram schematically showing a waveform of a fan radiation field pattern according to an embodiment of the present invention;

FIG. 3b is a diagram schematically showing a waveform of a pencil radiation field pattern according to an embodiment of the present invention;

FIG. 3c is a diagram schematically showing a waveform of a multi-point pencil radiation field pattern according to an embodiment of the present invention;

FIG. 4 is a diagram schematically showing connections of elements of an antenna device according to the second embodiment of the present invention;

FIG. 5 is a block diagram schematically showing an antenna device according to the second embodiment of the present invention;

FIG. 6 is a diagram schematically showing connections of elements of an antenna device according to the third embodiment of the present invention;

FIG. 7 is a block diagram schematically showing an antenna device according to the third embodiment of the present invention;

FIG. 8 is a diagram schematically showing connections of elements of an antenna device according to the fourth embodiment of the present invention; and

FIG. 9 is a block diagram schematically showing an antenna device according to the fourth embodiment of the present invention.

### DETAILED DESCRIPTION OF THE INVENTION

The present invention provides an antenna device, wherein cascaded antenna sets are applied to 24˜24.5 GHz, and the cascaded antenna sets are arranged into an array, and input signals are fed into the middle of the cascaded antenna sets to change a radiation field pattern, thereby improving the overall antenna gain.

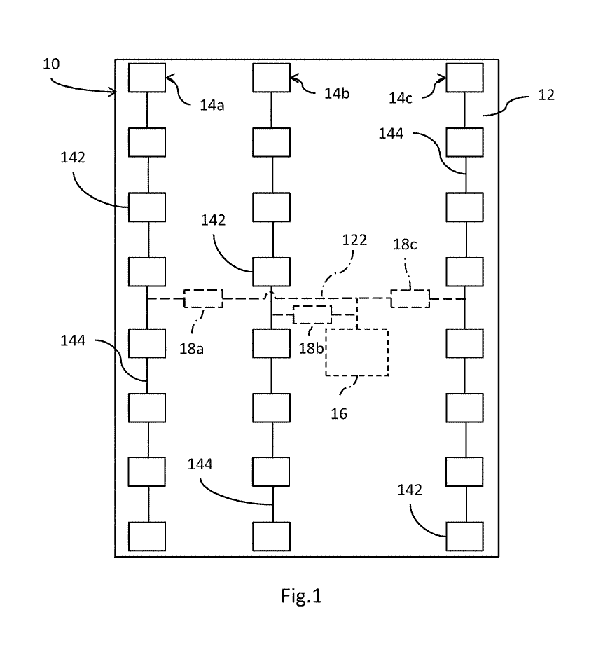

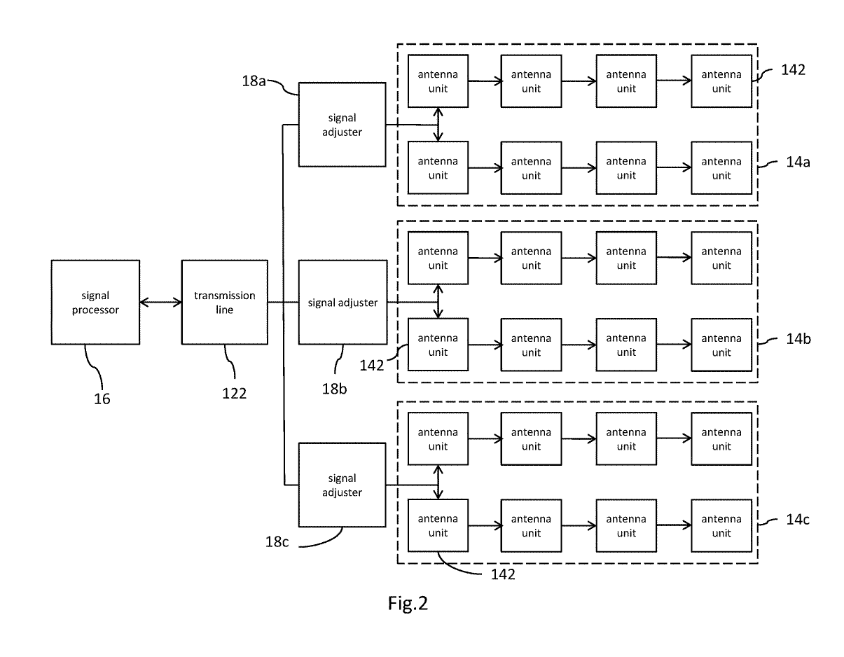

Firstly, refer to FIG. 1 and FIG. 2. An antenna 10 includes a substrate 12, three cascaded antenna sets 14a, 14b and 14c, and a signal processor 16. In the embodiment, the substrate 12 is exemplified by a printed circuit board. The substrate 12 has a first plane and a second plane. The cascaded antenna sets 14a, 14b and 14c are arranged on the first plane of the substrate 12. The cascaded antenna sets 14a, 14b and 14c respectively have a plurality of antenna units 142 and a plurality of microstrip lines 144. The microstrip lines 144 are arranged in the substrate 12. An amount of the antenna units 142 is even. In the embodiment, take eight antenna units 142 and seven microstrip lines for example. Every two antenna units 142 is electrically connected with one microstrip line 144, whereby the eight antenna units 142 are cascaded through the microstrip lines 144. The signal processor 16 is electrically connected with the middle microstrip line 144 of each cascaded antenna set 14a, 14b and 14c. In the embodiment, the signal processor 16 is electrically connected with the middle microstrip line 144 of each cascaded antenna set 14a, 14b and 14c through a transmission line 122 in the substrate 12. The signal processor 16 is arranged on, but not limited to, the second plane of the substrate 12. The signal processor 16 transmits at least one input signal to the cascaded antenna sets 14a, 14b and 14c.

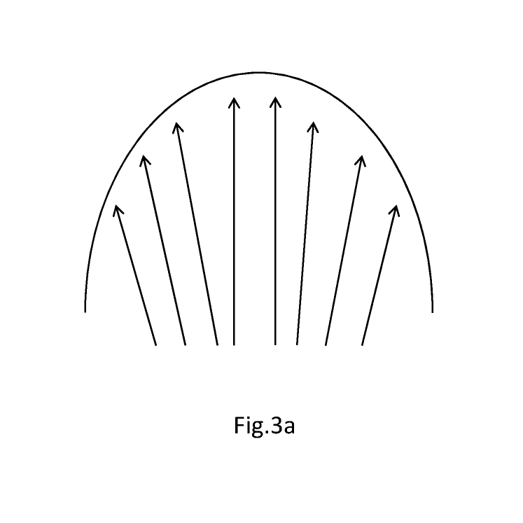

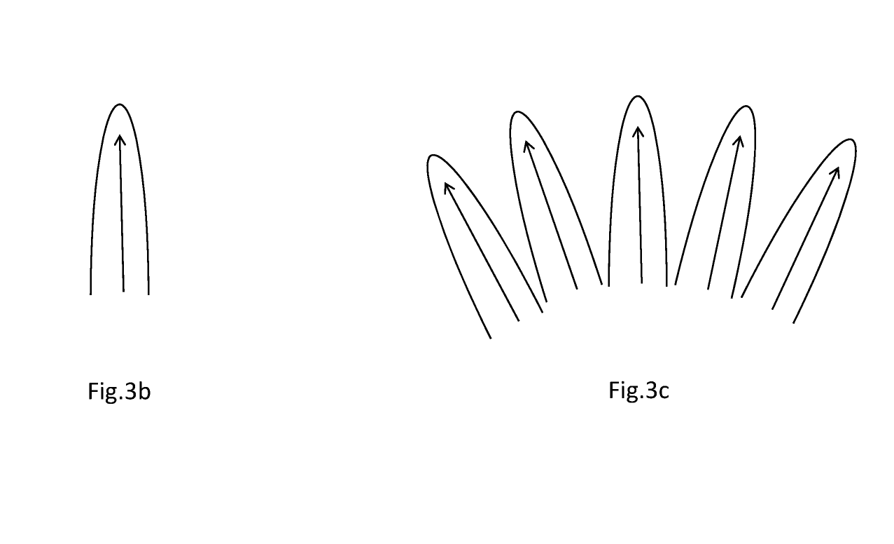

In the first embodiment, the transmission line 122 (shown by a dash line) is arranged on the second plane, which means that the transmission line 122 and the antenna units 142 are arranged on different planes. Additionally, the cascaded antenna sets 14a, 14b and 14c are spaced at different intervals. For example, an interval between the cascaded antenna set 14a and the cascaded antenna set 14b is closer than an interval between the cascaded antenna set 14b and the cascaded antenna set 14c. Meanwhile, the second plane of the substrate 12 is provided with three signal adjusters 18a, 18b, and 18c, which are power distributors, phase shifters, low noise amplifiers (LNAs), or power amplifiers (PAs). In the embodiment, the signal adjusters 18a, 18b, and 18c are power distributors. The amount of the signal adjusters is, but not limited to, three. The signal adjusters 18a, 18b, and 18c are electrically connected among the signal processor 16 and the middle microstrip lines 144 of the cascaded antenna sets 14a, 14b and 14c. The signal adjuster 18a is electrically connected between the signal processor 16 and the middle microstrip line 144 of the cascaded antenna set 14a. The signal adjuster 18b is electrically connected between the signal processor 16 and the middle microstrip line 144 of the cascaded antenna set 14b. The signal adjuster 18c is electrically connected between the signal processor 16 and the middle microstrip line 144 of the cascaded antenna set 14c. The signal adjusters 18a, 18b, and 18c adjust power of the input signal fed into each cascaded antenna set by the signal processor 16 using the intervals of the cascaded antenna sets 14a, 14b and 14c. For example, the field pattern required is obtained by adjusting the power and changing phases since the interval between the cascaded antenna set 14a and the cascaded antenna set 14b is closer. The field pattern required is obtained by adjusting the power and changing phases since the interval between the cascaded antenna set 14b and the cascaded antenna set 14c is farther. The input signal is transmitted to the cascaded antenna sets 14a, 14b and 14c, and then transmitted to the outside antenna units 142 from the middle antenna unit 142. As a result, a fan-beam radiation field pattern shown in FIG. 3a is changed into a pencil-beam radiation field pattern shown in FIG. 3b or a multi-point pencil-beam radiation field pattern shown in FIG. 3c, thereby improving the gain of the antenna device 10.

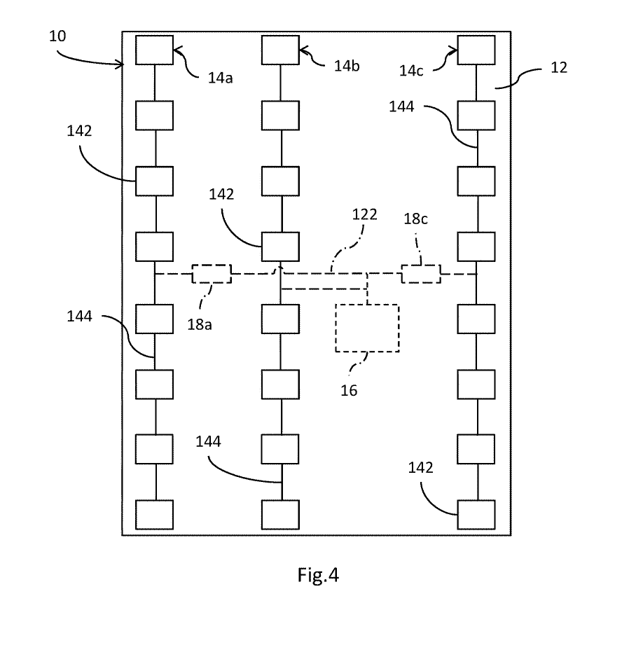

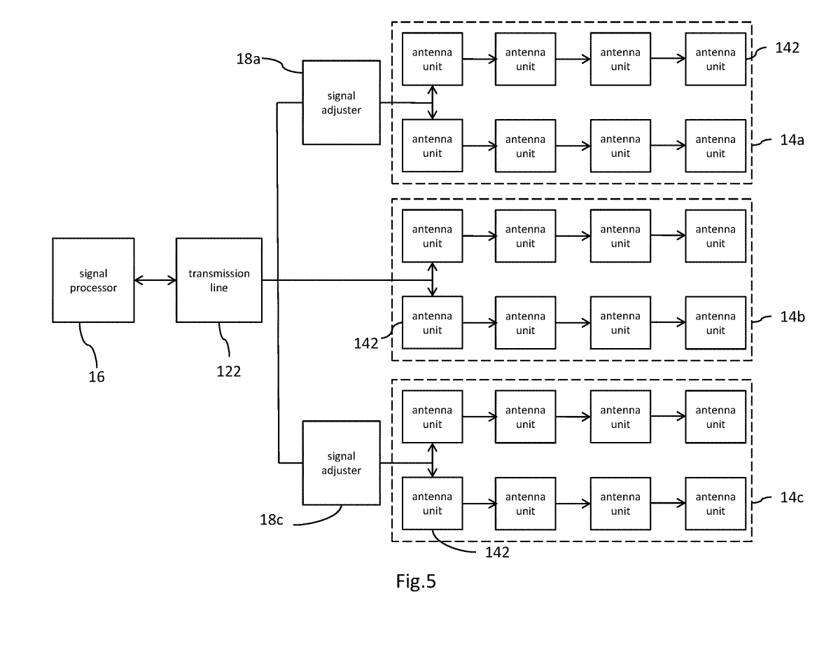

In addition to the first embodiment, the second embodiment is introduced below. Refer to FIG. 4 and FIG. 5. The second embodiment is different from the first embodiment in installation of the signal adjusters. The present invention introduces the second embodiment without any signal adjusters. In the second embodiment, the signal processor 16 is electrically connected with the middle microstrip line 144 of the cascaded antenna set 14b. In the present invention, the amount of the signal adjusters is not limited but changed according to the requirement of a user. Thus, at least one signal adjuster can be also used. Refer to FIG. 1. In the first embodiment, the cascaded antenna sets 14a, 14b and 14c are respectively connected with the signal adjusters 18a, 18b and 18c, wherein each set can adjust the radiation field pattern by itself In the second embodiment, although there is no signal adjuster connected with the middle microstrip line 144 of the cascaded antenna set 14b, the radiation field pattern can be still adjusted. As a result, a fan-beam radiation field pattern shown in FIG. 3a is changed into a pencil-beam radiation field pattern shown in FIG. 3b or a multi-point pencil-beam radiation field pattern shown in FIG. 3c, thereby improving the gain of the antenna device 10 without the cost of the signal adjusters.

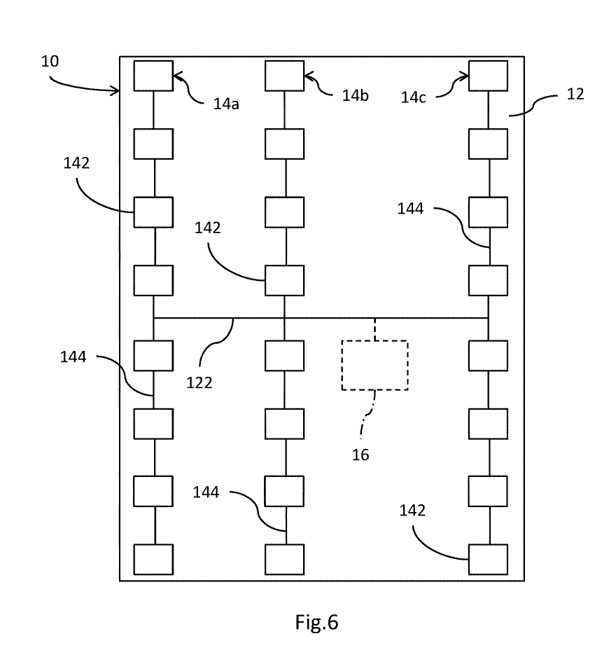

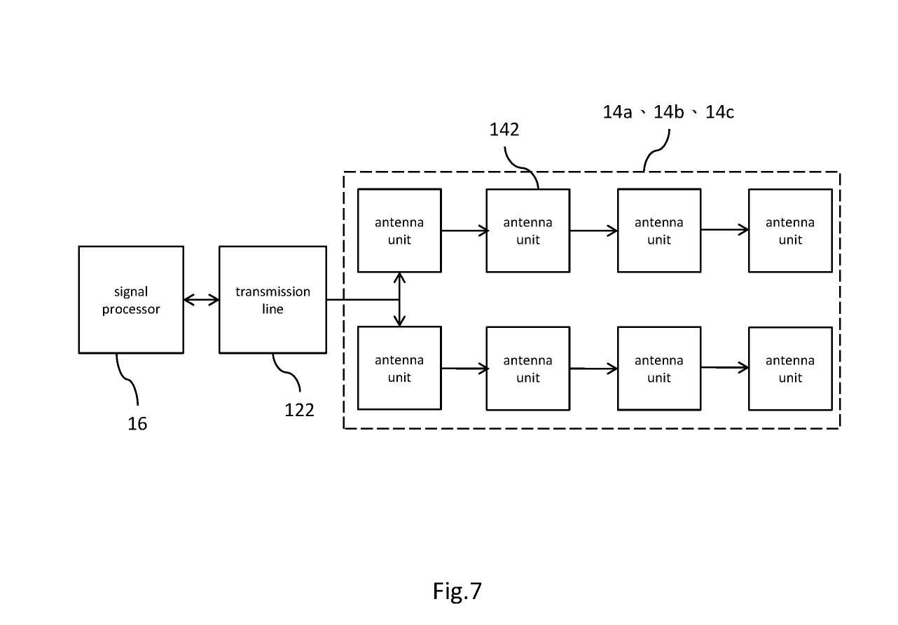

In addition to the first embodiment and the second embodiment, the third embodiment is introduced below. Refer to FIG. 6 and FIG. 7. The transmission line 122 is arranged on the first plane of the substrate 12, which means that the transmission line 122 and the antenna units 142 are arranged on the same plane. Meanwhile, the signal processor 16 directly transmits the input signal with different power to each cascaded antenna set 14a, 14b and 14c using different intervals and phases of the neighboring cascaded antenna sets 14a, 14b and 14c. For example, the power and radiation direction are adjusted according to impedances and a length of the line between the cascaded antenna set 14a and the cascaded antenna set 14b. The operation of the cascaded antenna set 14a and the cascaded antenna set 14b is the same to the operation of the cascaded antenna set 14b and the cascaded antenna set 14c, whereby the produced phases are changed according to the different impedances and distance between the cascaded antenna set 14b and the cascaded antenna set 14c. Then, the phases are transmitted to the outside antenna units 142 from the middle antenna unit 142. As a result, a fan-beam radiation field pattern shown in FIG. 3a is changed into a pencil-beam radiation field pattern shown in FIG. 3b or a multi-point pencil-beam radiation field pattern shown in FIG. 3c, thereby improving the gain of the antenna device 10.

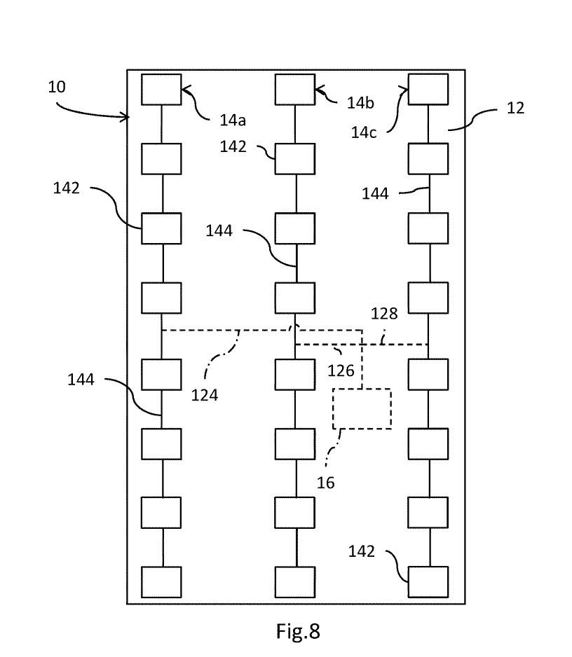

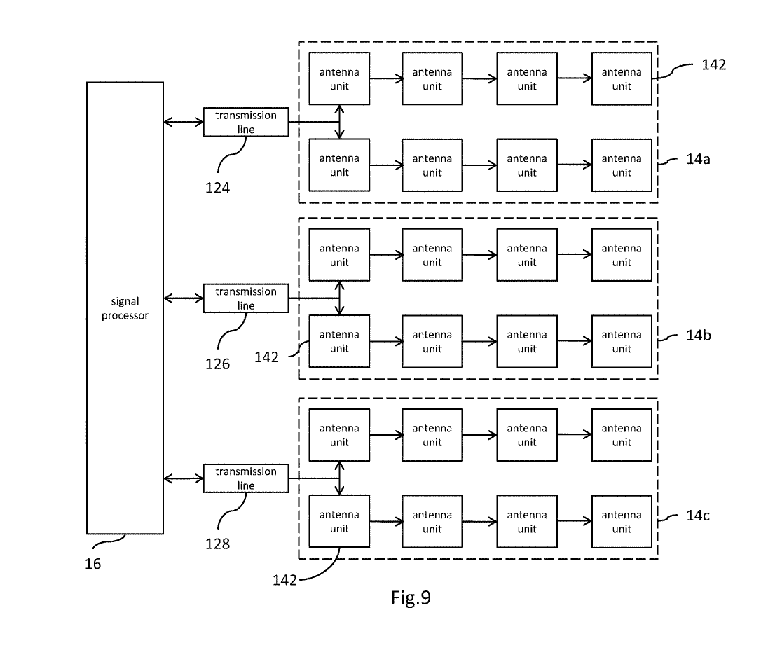

In addition to the abovementioned embodiments, the fourth embodiment is introduced below. Refer to FIG. 8 and FIG. 9. The signal processor 16 is electrically connected with three cascaded antenna sets 14a, 14b and 14c through three transmission lines 124, 126 and 128, respectively. The signal processor 16 is electrically connected with the cascaded antenna set 14a through the transmission line 124. The signal processor 16 is electrically connected with the cascaded antenna set 14b through the transmission line 126. The signal processor 16 is electrically connected with the cascaded antenna set 14c through the transmission line 128. Suppose that the intervals among the neighboring cascaded antenna sets 14a, 14b and 14c are equal. The signal processor 16 feeds each input signal into each cascaded antenna set 14a, 14b and 14c through each transmission line 124, 126 and 128 using unequal power distribution. Then, the input signal is transmitted to the outside antenna units 142 from the middle antenna unit 142. As a result, a fan-beam radiation field pattern is changed into a pencil-beam radiation field pattern or a multi-point pencil-beam radiation field pattern, thereby improving the gain of the antenna device 10.

In conclusion, the present invention feeds the input signal into the microstrip line of the middle antenna set, transmits the signal from the antenna unit neighboring the middle microstrip line to the outside antenna units, thereby changing the radiation field pattern of the antenna device, such as changing a fan-beam radiation field pattern into a pencil-beam radiation field pattern or a multi-point pencil-beam radiation field pattern to increase the antenna gain to above 25˜30 dbi. The amount of the cascaded antenna sets of the present invention is three, but the present invention is not limited thereto. Varied according to the requirement of the user, the amount of the cascaded antenna sets of the present invention is also four, five or more. The present invention mainly arranges many antenna units into an array and decreases the area the antenna device to satisfy the requirement of communication products with small volumes.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

What is claimed is:

1. An antenna device comprising:
a substrate having a first plane and a second plane;
a plurality of cascaded antenna sets arranged on said first plane of said substrate, and each said cascaded antenna set has a plurality of antenna units and a plurality of microstrip lines, and every two said antenna units is electrically connected with one said microstrip line, whereby said antenna units are cascaded through said microstrip lines; and
a signal processor electrically connected with middle said microstrip line of each said cascaded antenna set, and at least one input signal is fed into said cascaded antenna sets, and then transmitted to outside said antenna units from middle said antenna unit, thereby improving a gain of said cascaded antenna sets.

2. The antenna device of claim 1, wherein said substrate is provided with at least one transmission line electrically connected with said signal processor and said middle said microstrip line of each said cascaded antenna set.

3. The antenna device of claim 2, wherein said transmission line is arranged on said second plane of said substrate, and said cascaded antenna sets are spaced at different intervals.

4. The antenna device of claim 3, further comprising at least one signal adjuster arranged on said second plane of said substrate, and said at least one signal adjuster is electrically connected between said signal processor and said middle said microstrip line of each said cascaded antenna set, and said signal adjuster adjusts power of said input signal fed into each said cascaded antenna set by said signal processor using said intervals of said cascaded antenna sets.

5. The antenna device of claim 4, wherein said signal adjuster is a power distributor, a phase shifter, a low noise amplifier (LNA), or a power amplifier (PA).

6. The antenna device of claim 2, wherein said transmission line is arranged on said first plane of said substrate, and said signal processor transmits said input signal with different power to each said cascaded antenna set using different intervals and phases of neighboring said cascaded antenna sets.

7. The antenna device of claim 2, wherein said signal processor is electrically connected with one said cascaded antenna set through one said transmission line, and said signal processor feeds each said input signal into each said cascaded antenna set through each said transmission line using unequal power distribution.

8. The antenna device of claim 1, wherein an amount of said antenna units is even.

9. The antenna device of claim 1, wherein said substrate is a printed circuit board.

10. The antenna device of claim 1, wherein said cascaded antenna sets are applied to 24˜24.5 GHz.

11. The antenna device of claim 1, wherein said microstrip line is arranged in said substrate.
